(19) United States
(12) Patent Application Publication
(10) Pub. No.: US 2012/0284648 A1
(43) Pub. Date: Nov. 8, 2012

(54) Cascading Data Displays and Methods

(76) Inventor: Michael John Marshall, Shreveport, LA (US)

(21) Appl. No.: 13/451,205

(22) Filed: Apr. 19, 2012

Related U.S. Application Data
(60) Provisional application No. 61/477,920, filed on Apr. 21, 2011.
(60) Provisional application No. 61/579,152, filed on Dec. 22, 2011.

(51) Int. Cl. G06F 3/01; G06F 15/16

(52) U.S. Cl. 715/753

(57) ABSTRACT

A cascading data display system for use in message or discussion forums hosted and maintained via computer-aided media, comprising a discussion board including one or more columns and one or more rows in each column; a posting component adapted to post user-initiated messages in the row or rows of each column of the discussion board; and an arranging component adapted to arrange the user-initiated messages into each column based on the status of the messages. A cascading data display method includes providing a discussion board hosted and maintained via computer-aided media comprising one or more columns and a plurality of rows; posting user-initiated messages in the column or columns and rows of the discussion board; and arranging the user-initiated messages into the one or more columns based on a status of the messages.

### CROSS-REFERENCE TO RELATED APPLICATIONS

This application claims the benefit of U.S. provisional application No. 61/477,920, filed on Apr. 21, 2011 and entitled “Cascading Data Display Method”, and U.S. provisional application No. 61/579,152, filed on Dec. 22, 2011 and entitled “A Method For Displaying Data In a Cascading, Column-Based Format”, each of which provisional applications is incorporated by reference herein in its entirety.

### FIELD

Illustrative embodiments of the disclosure relate to computer software and computer operational methods. More particularly, illustrative embodiments of the disclosure relate to methods of displaying data in computer-aided discussion or message board forum that allows a user to post data and/or respond to posted data in a hierarchical format utilizing one or more columns that provide the user with access to both the selected data and the appropriate context for understanding the genesis and various generations of responses to the data.

### BACKGROUND

Currently, various systems exist that allow users to interact over the internet through discussion or message boards. One such method of hosting and moderating computer-aided message and discussion forums allows a user to view and respond to a data post in a single column, linear display format where only one column is used to show posts in some sort of order, like chronologically, or by a ranking system. Responses to data posts may be inserted at the end of the thread of all posts, or may be inserted directly under the post being responded to. In this type of a format, hierarchical data is typically provided in the left margin to show which posts are responses and which other posts are responses to responses. As the thread grows in its number of posts, whether response posts are added to the end of the thread or under their respective parent-post, the thread as a whole becomes unwieldy, the sub-conversation becomes difficult to follow, and the context of the sub-conversation becomes hard to understand. These types of threads also challenge the user to stay focused on the broad theme of the thread because of potential distractions due to irrelevant posts and the amount of time required to keep track of all post-reply relationships.

Other systems of providing and supporting computer-aided message or discussion boards provide for a detailed and complex threaded format or a cumbersome semi-threaded format. These typical online discussion forums or bulletin boards utilize either a fully threaded format whereby responses to a post appear directly below and typically set off to the right of an original post or a semi-threaded format where all replies are grouped under a general topic and sorted according to the time posted. While these formats can be useful for viewing and responding to certain information, the limitations of each format are obvious when considering multiple post/reply branches where users are responding to replies deep within other replies to an original post.

To respond to the obvious problems that arise when threads fill up with original posts and reply posts, these internet discussion boards have adopted techniques to keep the user more aware of how each posts relates to the overall hierarchy of relationships between individual posts. Common techniques include the use of indented lines in the margins of the thread to show the parent-post of each post or the adoption of a control device within the post itself that is able to give hierarchical or contextual information relevant to the individual post. Many recent discussion boards also utilize “plus boxes” in the margin to provide the user the ability to minimize a subsection of posts and potentially remove distracting sub conversations that the user may not want to view.

The system and method described herein provides users with the ability to navigate among various data posts without the traditional “tree” type viewing hierarchy that can be distracting and unhelpful for complicated multi-generation data posts by utilizing one or more columns to display both the original post and various replies selected by the user in one or more columns while allowing the user to select certain posts as the active post and change the arrangement of the posts to show the full hierarchy of responses.

### SUMMARY

A cascading data display system for use in message or discussion forums hosted and maintained via computer-aided media, said system comprising a discussion board component including one or more columns and one or more rows in each column; a posting component adapted to post user-initiated messages in the row or rows of each column of the discussion board component; and an arranging component adapted to arrange the user-initiated messages into each column based on the status of the user-initiated messages as an original message, a responsive message or an active message selected by a user.

A cascading data display method, said method comprising providing a discussion board hosted and maintained via computer-aided media comprising one or more columns and a plurality of rows; posting user-initiated messages in the column or columns and rows of the discussion board; and arranging the user-initiated messages into the one or more columns based on a status of the user-initiated messages as an original message, a responsive message or an active message that is selected by a user.

### BRIEF DESCRIPTION OF THE DRAWINGS

Having thus described the invention in general terms, reference will now be made to the accompanying drawings, which are not necessarily drawn to scale, and wherein:

FIG. 1 is a block diagram of an illustrative single-column embodiment of the cascading data display system;

FIG. 2 is a block diagram of an illustrative double-column embodiment of the cascading data display system;

FIG. 3 is a block diagram of an illustrative multi-column embodiment of the cascading data display system;

FIGS. 4-8 are schematic block diagrams illustrating an exemplary posting sequence in a single-column format according to implementation of the illustrative embodiment of the cascading data display system illustrated in FIG. 1;

FIGS. 9-16 are schematic block diagrams illustrating an exemplary posting sequence in a double-column format according to implementation of the illustrative embodiment of the cascading data display system illustrated in FIG. 2;

FIG. 17 is an exemplary screen shot which illustrates an exemplary posting sequence in a multi-column format according to an illustrative embodiment of the cascading data display system illustrated in FIG. 3;

FIG. 18 is a flow diagram of an illustrative single-column embodiment of the cascading data display method; and

FIG. 19 is a flow diagram of an illustrative double-column embodiment of the cascading data display method.

FIG. 20 is a flow diagram of an illustrative multi-column embodiment of the cascading data display method.

### DETAILED DESCRIPTION OF THE INVENTION

The present inventions now will be described more fully hereinafter with reference to the accompanying drawings, in which some examples of the embodiments of the inventions are shown. Indeed, these inventions may be embodied in many different forms and should not be construed as limited to the embodiments set forth herein; rather, these embodiments are provided by way of example so that this disclosure will satisfy applicable legal requirements Like numbers refer to like elements throughout.

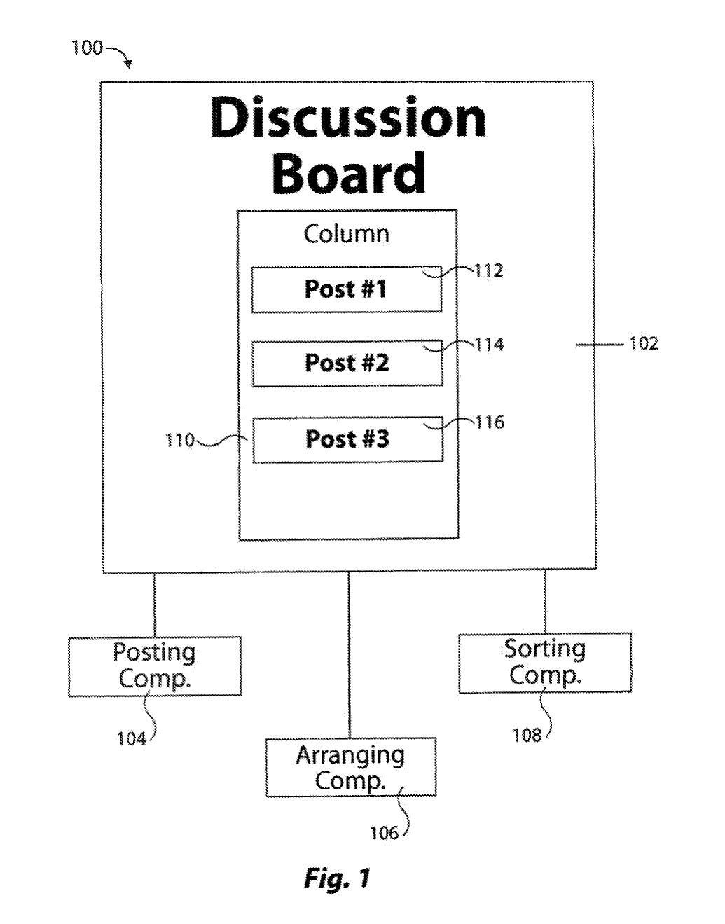

The various illustrative embodiments of this invention are presented herein and involve computer-aided discussion forums or message boards that are connected through a network of computers where information (whether text, video, audio or other communication medium), hereinafter message or post, is posted and responses to the messages are allowed. Referring initially to FIG. 1 of the drawings, an illustrative embodiment of the cascading data display system, hereinafter system, is generally indicated by reference numeral 1. In some embodiments, the system 100 may include a discussion board 102 wherein a posting component 104 displays responsive messages 114, 116 of users directly beneath an original message 112 in a single column 110. The original message 112 and the responsive messages 114, 116 are arranged via an arranging component 106 in the column 110 based on each message's status as an original post, an active post or a responsive post. In some embodiments, a sorting component 108 may sort the messages in ascending or descending order in the column 110 based on a default algorithm or the user's selection.

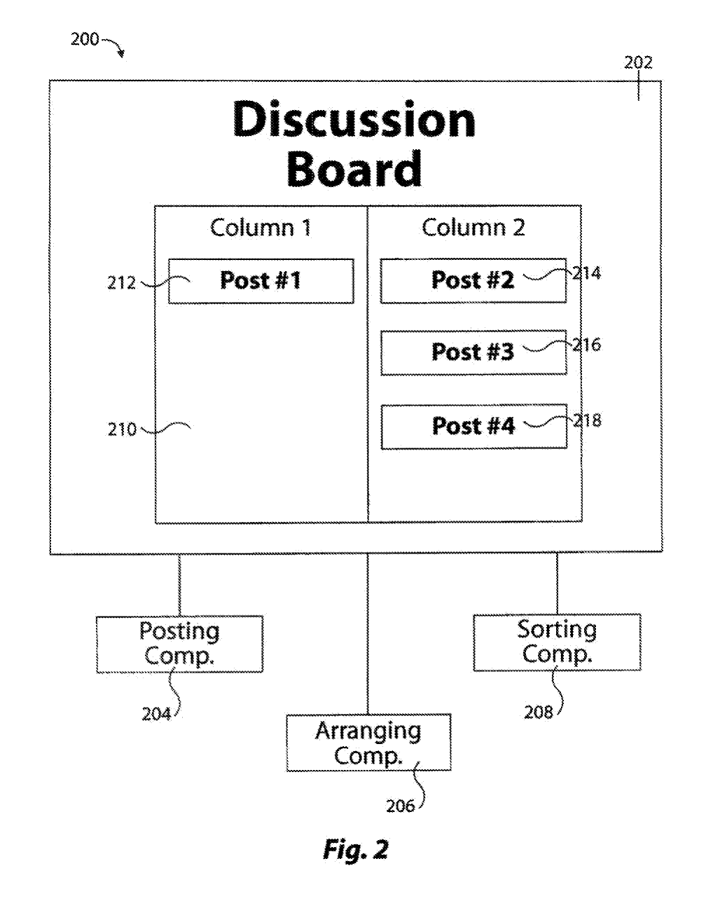

Referring next to FIG. 2 of the drawings, in some embodiments, the system 200 may include an discussion board 202 having two adjacent columns 210 for users to post messages via a posting component 204. An arranging component 206 arranges the posts based on each post's status as an original post 212, an active post 212 or a responsive post 214-218. In some embodiments, a sorting component 208 may sort the various posts in ascending or descending order within each column 210 based on a default algorithm or a user-selected preference.

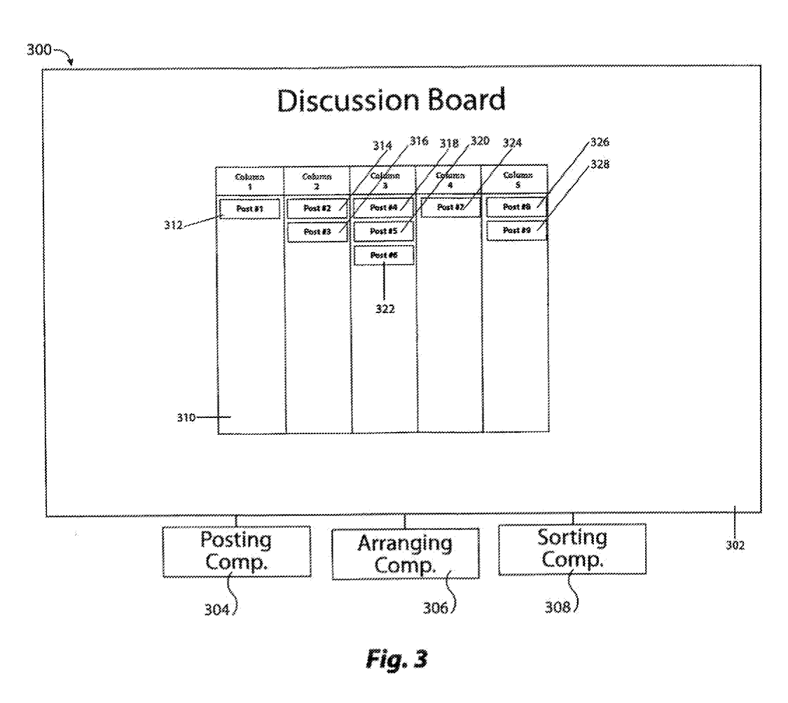

Referring next to FIG. 3 of the drawings, in some embodiments the system 300 may include a discussion board 302 that uses two or more adjacent columns 310 in which users post messages via a posting component 304. The system 300 further includes an arranging component 306 which arranges the posts based on each post's status as an original post 312, an active post 314, 318, and 324 or a responsive post 314 and 316 responding to 312, 318, 320, 322 responding to 314, 324 responding to 318, and 326 and 328 responding to 324. Further, the sorting component 308 may sort the various posts within each column 310 in ascending or descending order based on a default algorithm or a user-selected preference. Each of these embodiments allows the user to identify the relationship of a post to other posts by viewing the overall hierarchy of multiple generations of posts contained in either the single column, the dual columns or in successive columns.

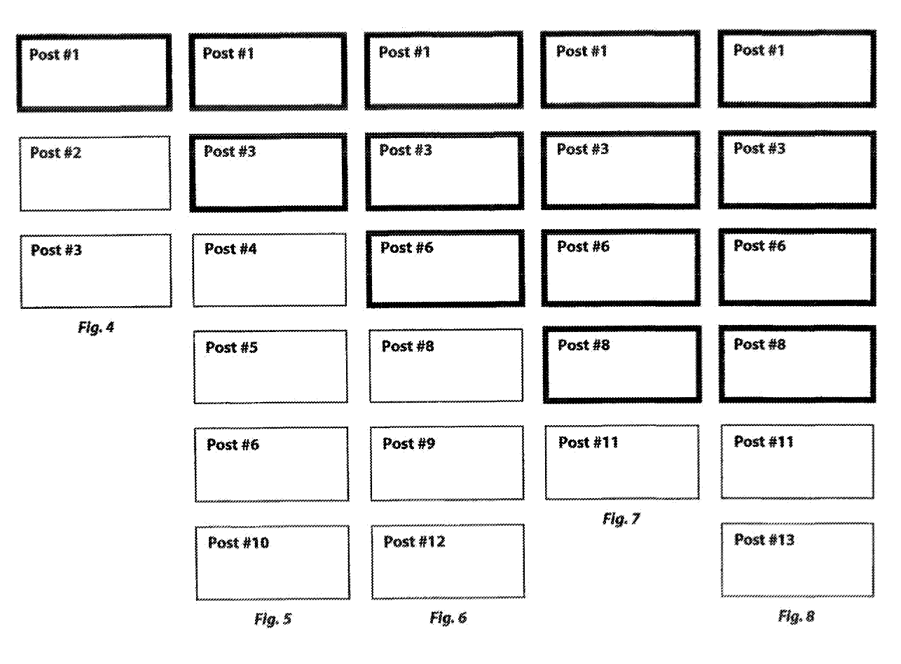

To further demonstrate the application of the systems and methods for posting information in a discussion forum, each embodiment is illustrative and discussed fully herein. An exemplary posting scenario in implementation of the system 100 of FIG. 1 is illustrated in FIGS. 4-8. FIG. 4 shows an original data post (Post #1) with two response posts (Post #2 and Post #3) to the discussion board 102. The first post (Post #1) is originally loaded at the top of the column and all responsive posts (Post #2 and Post #3) are arranged directly below Post#1. These responses may be sorted via the sorting component 108 (FIG. 1) in descending or ascending order based on a default sorting algorithm or a user-selected preference (such as time posted, rating, alphabetical, etc.). As shown in FIG. 5, if a user selects and activates a responsive post (Post #3), the selected active post is appended directly below the original post (Post #1) and all responsive posts to Post #3 (Posts #4, #5, #6, and #10) are displayed directly below Post #1 and Post #3. The user can continue to select, activate and/or respond to the various responsive posts, and each selected post will append directly below the post to which it is responding as demonstrated in FIG. 6, where the user selects Post #6 and the responsive posts (Posts #8, #9, and #12) appear directly below Post #6. FIG. 7 illustrates a scenario in which the user selects Post #8 and the only responsive post (Post#11) appears directly below Post #8. Finally, in the event that a user desires to respond to a particular activated post (Post #8), the response will be appended below the other responses to the activated post as shown in FIG. 8, where the user posts a response to Post #8 and the response appears as Post #13.

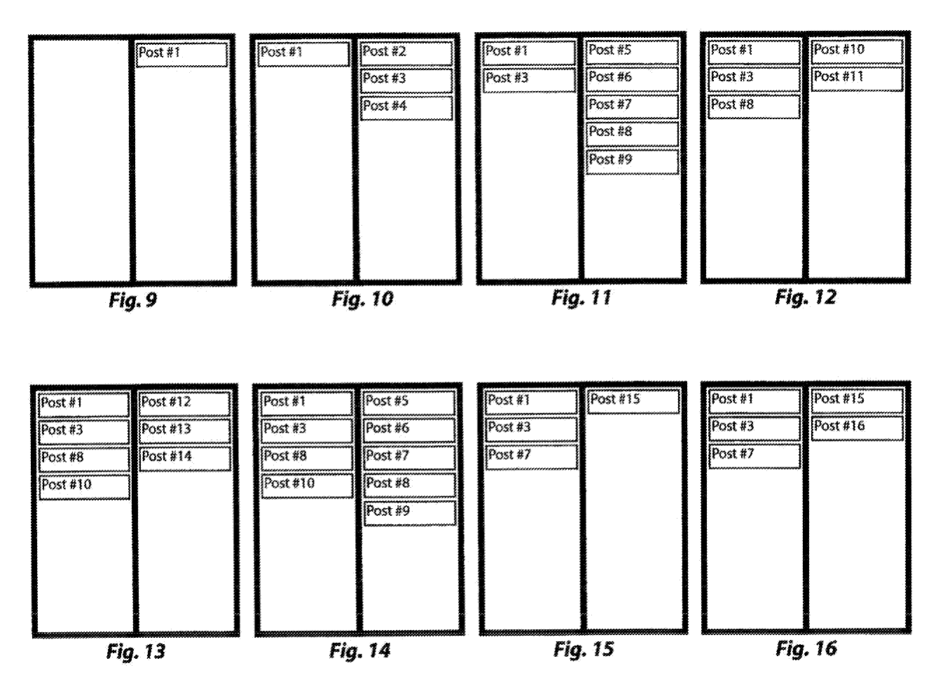

An exemplary posting scenario in implementation of the system 200 of FIG. 2 is illustrated in FIGS. 9-16. In this embodiment, the first post (Post #1) of an online conversation is originally loaded in the right column as illustrated in FIG. 9. If Post #1 is selected and deemed the active post, Post #1 moves to the left column and the right column is populated with all responsive posts to Post #1, indicated as Post #2, Post #3, and Post #4 in FIG. 10. These responses may be sorted by the sorting component 208 (FIG. 2) and displayed in descending or ascending order based on the default algorithm or a user-selected preference (such as time posted, rating, alphabetical, etc.). Next, when a post is selected and activated from the list of responsive posts in the right column, the selected post, shown as Post #3 in FIG. 11, moves to the left column below the Post #1 and becomes the active post, and all responsive posts to Post #3 are displayed in the right column (shown as Post #5, Post #6, Post #7, Post #8, and Post #9 in FIG. 11). The user can continue to select, activate and/or respond to the various responsive posts in the right column, and each selected post is arranged by the arranging component 206 (FIG. 2) to the left column as depicted in FIG. 12, where the user selects and activates Post #8, which moves to the left column and the responsive posts to Post #8, Post #10 and Post #11 are arranged into the right column. FIG. 13 illustrates a scenario where the user selects and activates Post #10 and Post #10 moves to the left column. The responsive posts to Post #10 are Post #12, Post #13 and Post #14, which are arranged into the right column. If the user desires to view or respond to a post higher up in the chain of responses, the user simply can select and activate the post in the left column as shown in FIG. 14, where the user selects Post #3 and the right column is arranged to show all responses to Post #3 (which in this case is Posts #5-9). FIG. 15 illustrates a scenario where the user selects Post #7 and Post #7 is moved from the right column to the left column under the post to which it is responsive (Post #3). The responsive post to Post #7 (Post #15) is loaded into the right column. Finally, in the event that a user responds to a particular activated post, the response will be appended in the right column to show that it was a response to the active post, as demonstrated in FIG. 16, where the user posts a response via the posting component 204 (FIG. 2) to Post #7 and the arranging component 206 (FIG. 2) arranges the post as Post #16 in the right column. The scope of this disclosure also includes a discussion board 210 (FIG. 2) where the natural progression of the language which is used in the posts actually reads from right to left (such as Chinese) and original or active posts are therefore arranged into the right column and responses are then arranged to the left column.

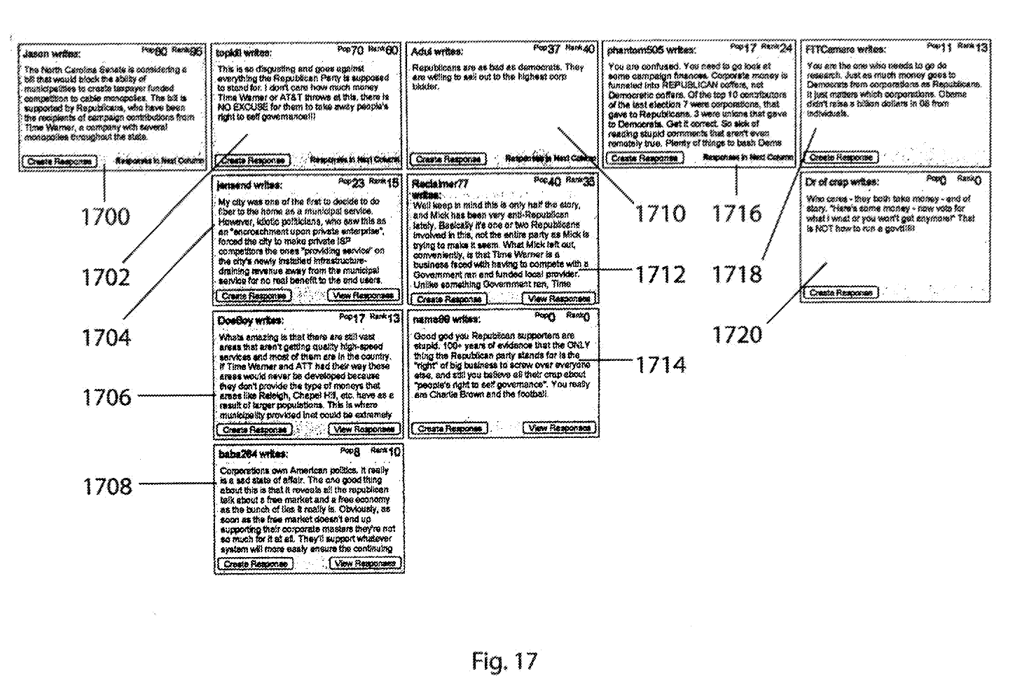

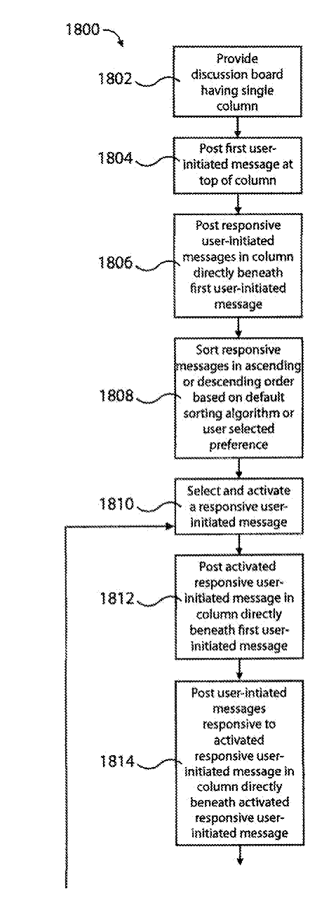

FIG. 17 describes a third embodiment of the invention whereby the discussion board 302 (FIG. 3) contains multiple columns 310 (FIG. 3) to which data can be posted. FIG. 17 includes an original data post 1700 posted by the posting component 304 (FIG. 3) in the far left column and four responses to data post 1700, which are data posts 1702, 1704, 1706 and 1708. These responses are arranged by the arranging component 306 (FIG. 3) into the column adjacent to the first column on the far left to display to the user that each post is a response to the top post in the adjacent column. These responsive posts may then be sorted by the sorting component 308 (FIG. 3) in accordance with the default sorting algorithm or a user-selected order. Likewise, Posts 1710, 1712, and 1714 are responsive posts to the top post of the adjacent column, Post 1702 and are posted through the posting component 304 (FIG. 3) to the adjacent column and sorted by the sorting component 308 (FIG. 3). Thus, under this embodiment, each responsive post is arranged into a column adjacent to the post to which it is responding. If the user selects a particular post as an active post, that post will be arranged by the arranging component 306 (FIG. 3) to the top of its respective column and all posts responding to the active post will then be arranged in the columns adjacent to the active post.

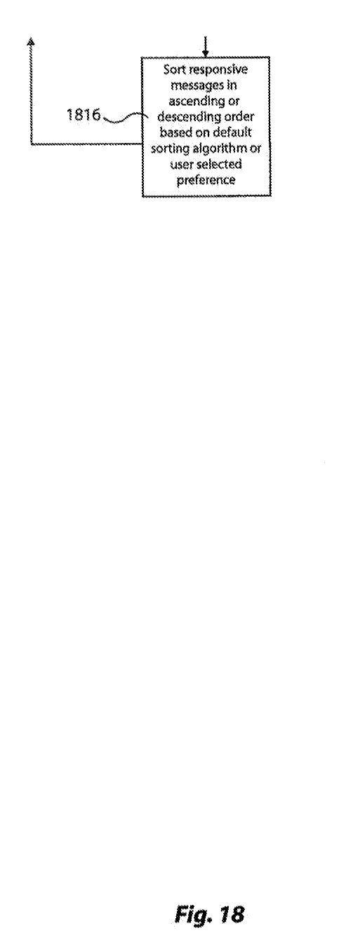

The method detailed in this disclosure is demonstrated in the flow diagrams listed as FIGS. 18, 19 and 20.

Referring next to FIG. 18 of the drawings, an illustrative single-column embodiment of the cascading data display method 1800 is illustrated. In block 1802, a discussion board with a single column is provided. In block 1804, an original user-initiated message is posted to the discussion board and arranged in the top row of the column on the discussion board. In block 1806, all subsequent user-initiated messages that are responsive to the original post are posted or arranged directly below the original or first user-initiated message. In block 1808, a responsive user-initiated message may be sorted in ascending or descending order based on a default sorting algorithm or a user-selected preference. In block 1810, a responsive user-initiated message may be selected and activated. In block 1812, an activated responsive user-initiated message may be posted in the column directly beneath the responsive user-initiated message activated in block 1808. In block 1814, user-initiated messages which are responsive to the responsive user-initiated message activated in block 1810 are posted in the column directly beneath the activated responsive user-initiated message. In block 1816, the responsive messages to the active message may be sorted in ascending or descending order in the column in accordance with a default sorting algorithm or a user-selected order such as time, popularity, rank, or feedback. If the user selects and activates a responsive post to the first active post, the steps of 1810 through 1816 are repeated and the second active post is arranged or posted below the first active post and all responsive posts to the second active post are then posted or arranged directly below the second active post and sorted in accordance with the default sorting algorithm or a user-selected order.

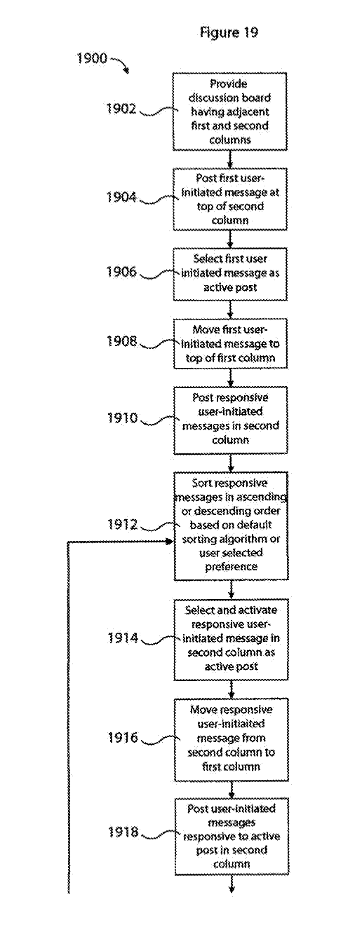

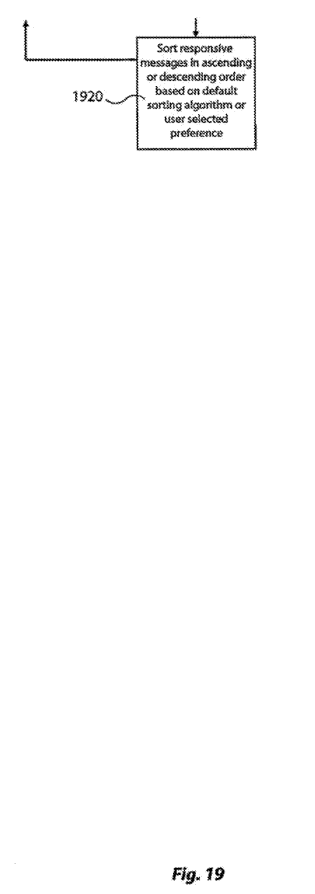

Referring next to FIG. 19 of the drawings, an illustrative double-column embodiment of the cascading data display method 1900 is illustrated. In block 1902, a discussion board with a first (left-hand) column and an adjacent second (right-hand) column is provided. In block 1904, an original user-initiated message is posted to the discussion board and arranged at the top of the right column. In block 1906, the original or first user-initiated message may be selected as the active post and in block 1908, the post is arranged at the top of the left column. In block 1910, all responsive posts to that active original post are posted or arranged in the right column and may be sorted as shown by block 1912 in accordance with a default sorting algorithm or a user-selected order such as time, popularity, rank, or feedback. In block 1914, the user may select and activate a responsive user-initiated message in the right column as an active post. In block 1916, the responsive user-initiated message is moved from the right column to the left column. In block 1918, all responsive posts to that new active responsive message are posted or arranged in the right column and may be sorted as shown by block 1920 in accordance with a default sorting algorithm or a user-selected order such as time, popularity, rank, or feedback. If the user selects and activates a responsive post from the second column to the first active responsive post, the steps detailed in block 1914 through 1920 are repeated and the second active responsive post is arranged or posted in the first column below the first active post and all responsive posts to the second active responsive post are then posted or arranged in the second column and may be sorted in accordance with the default sorting algorithm or a user-selected order.

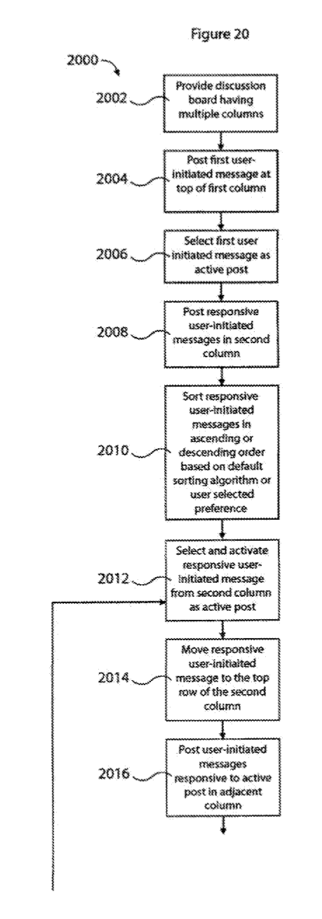

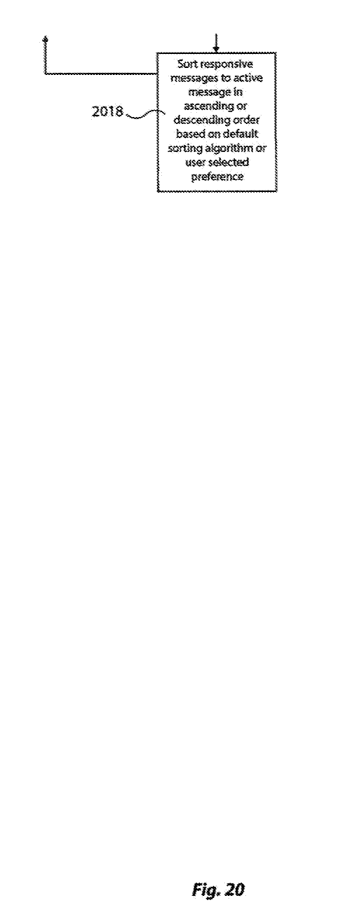

Referring next to FIG. 20 of the drawings, an illustrative multi-column embodiment of the cascading data display method 2000 is illustrated. In block 2002, a discussion board with multiple columns is provided. In block 2004, an original user-initiated message is posted to the discussion board and arranged at the top of the first column. In block 2006, the user can select and activate the original post, and in block 2008, all responsive posts to that active original post will be posted or arranged in the second column. In block 2010, all responsive posts may be sorted in accordance with a default sorting algorithm or a user-selected order such as time, popularity, rank, or feedback. In block 2012, the user may select and activate a responsive post (first active responsive post) from the second column, and in block 2014, the first active responsive post will be arranged at the top of the second column. In block 2016, all responsive posts to the first active responsive post will be posted or arranged into a column adjacent to the second column, and in block 2018, the responsive posts may be sorted in accordance with a default sorting algorithm or a user-selected order such as time, popularity, rank, or feedback 2012. If the user continues posting responses to the active post or selecting new active posts, the steps detailed in blocks 2012 through 2018 will be repeated and that new active post will be arranged at the top of its respective column and all responsive posts to that active post will be arranged in the column adjacent to the column containing the active post and may be sorted in accordance with a default sorting algorithm or a user-selected order such as time, popularity, rank, or feedback.

While the written description of the invention provided above enables one of ordinary skill in the art to make and use what is considered currently to be the best mode of the invention, those of ordinary skill will understand and appreciate the existence of variations, combinations, and equivalents of the specific embodiments, systems, methods, and examples contained herein. Thus, the invention should not be limited by the above-described embodiments, systems, methods and examples provided; rather, the invention encompasses all embodiments, systems, and methods within the scope and spirit of the invention as claimed.

What is claimed is:

1. A cascading data display system for use in message or discussion forums hosted and maintained via computer-aided media, said system comprising:
a discussion board component including one or more columns and one or more rows in each column;
a posting component adapted to post user-initiated messages in the row or rows of each column of the discussion board component; and
an arranging component adapted to arrange the user-initiated messages into each column based on the status of the user-initiated messages as an original message, a responsive message or an active message selected by a user.

2. The system according to claim 1 further comprising a sorting component adapted to sort responsive messages into a single column of the one or more columns based on a default sorting algorithm that sorts the responsive messages according to criteria comprising alphabetical order, user feedback, user ranking, popularity, posting date and time or user-selected criteria.

3. The system according to claim 1, wherein the discussion board component comprises left and right columns and a plurality of the rows in each column, the arranging component is adapted to arrange an original one of the user-initiated messages in a top row of the left column and arrange responsive messages to the original message in respective rows in the right column.

4. The system according to claim 3, wherein the arranging component is further adapted to arrange the active message selected by the user from among the responsive messages into a row below the original message in the left column and responsive messages to the active message into the right column.

5. The system according to claim 4, wherein the posting component is adapted to post responsive messages to the original or active message to a row in the right column below existing responsive messages.

6. The system according to claim 1, wherein the discussion board component comprises left and right columns and a plurality of rows in each column, the arranging component is adapted to arrange an original user-initiated message in a top row of the right column and arrange responsive messages to the original message in respective rows in the left column.

7. The system according to claim 6, wherein the arranging component is further adapted to arrange the active message selected by the user from among the responsive messages into a row below the original message in the right column and responsive messages to the active message into the left column.

8. The system according to claim 7, wherein the posting component is adapted to post responsive messages to the original or active message to a row in the left column below existing responsive messages.

9. The system according to claim 1, wherein the discussion board component comprises a single column and one or more rows in the single column, the posting component is adapted to post the original message at a top row of the single column and responsive messages to the original message directly below the original message and the arranging component is adapted to arrange responsive messages to the original message into respective rows below the original message.

10. The system according to claim 9, wherein the arranging component is adapted to move an active message to a row directly below the original message or responsive message when the user selects the active message from among the responsive messages and the arranging component is adapted to arrange responsive messages to the active message in rows directly below the active message.

11. The system according to claim 1, wherein the posting component is adapted to post the original message in a top row of a first column and a first set of responsive messages to the original message in a second column adjacent to the first column, the arranging component is adapted to arrange a second set of responsive messages responsive to a user-activated responsive message in the second column, into rows in a third column, the arranging component is adapted to arrange a third set of responsive messages responsive to a user-activated responsive message in the third column, into rows in a fourth column, the arranging component adapted to continue arranging responsive messages to a user-activated responsive message in a previous column by arranging the responsive messages to the user-activated message into a new column directly adjacent to the previous column.

12. The system according to claim 11, wherein the arranging component is adapted to move an active message selected by the user to a top row of a column in which the active message is located.

13. A cascading data display method, said method comprising:
providing a discussion board hosted and maintained via computer-aided media comprising one or more columns and a plurality of rows;
posting user-initiated messages in the column or columns and rows of the discussion board; and
arranging the user-initiated messages into the one or more columns based on a status of the user-initiated messages as an original message, a responsive message or an active message that is selected by a user.

14. The method according to claim 13 further comprising sorting the responsive messages arranged into the one or more columns based on a default sorting algorithm that sorts the response messages according to criteria comprising user feedback, user ranking, popularity or posting date and time or a user-selected order.

15. The method according to claim 13, wherein providing a discussion board comprises providing a discussion board comprising a first column and a second column and a plurality of rows in each column and further comprising posting an original message in a first row in the first column, posting and arranging responsive messages to the original message in the second column and sorting responsive messages to the original message into respective rows within the second column in accordance with a default algorithm or a user-selected order.

16. The method according to claim 15 further comprising having a user select or activate a responsive message in the second column and further comprising arranging the selected or activated responsive message into the first column in a row directly below a user-initiated message to which the selected or activated responsive message is responsive and posting and arranging responsive messages to the selected or activated responsive message into the second column, and further comprising sorting the responsive messages in accordance with a default algorithm or a user-selected order.

17. The method according to claim 13, further comprising providing a discussion board comprising a single column having a plurality of rows and further comprising posting an original message in a first row of the column, posting and arranging responsive messages to the original message directly below the original message in the column and sorting responsive messages to the original message into the rows directly below the original message in accordance with a default algorithm or a user-selected order.

18. The method according to claim 17, further comprising having a user selector activate a responsive message from a list of responsive messages below the original message and further comprising arranging the selected or activated responsive message into a row directly below a message to which the selected or activated responsive message is responsive and posting and arranging responsive messages to the selected or activated responsive message below the selected or activated responsive message and further comprising sorting the responsive messages in accordance with a default algorithm or a user-selected order.

19. The method according to claim 13, wherein providing a discussion board comprises providing a discussion board comprising a plurality of columns and a plurality of rows, further comprising posting the original message in a first row in a first column, posting and arranging responsive messages to the original message in a second column adjacent to the first column and sorting responsive messages responsive to the original message within the second column in accordance with a default algorithm or a user-selected order, posting and arranging responsive messages to a user-activated responsive message from the second column in a third column adjacent to the first column and sorting responsive messages responsive to the user-activated message within the third column in accordance with a default algorithm or a user-selected order, and continuing to post and arrange responsive messages to a user-activated responsive message from a previous column to a column adjacent to the previous column and sorting responsive messages responsive to the user-activated message within the previous column in accordance with a default algorithm or a user-selected order.

20. The method according to claim 19, further comprising having a user select or activate a responsive message from a list of responsive messages in a column and arranging the selected and activated message into a top row of the column in which the responsive message is located.
